(19) United States
(12) Patent Application Publication
(10) Pub. No.: US 2007/0231662 A1
(43) Pub. Date: Oct. 4, 2007

(54) Separator for fuel cell, method of producing the separator, and method of assembling the fuel cell

(75) Inventors: Shuhei Goto, Utsunomiya-shi (JP); Seiji Sugiura, Utsunomiya-shi (JP); So Fujiwara, Yaita-shi (JP); Daisuke Okonogi, Shioya-gun (JP); Narutoshi Sugita, Utsunomiya-shi (JP); Mikihiko Kimura, Gyoda-shi (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/729,043

(22) Filed: Mar. 28, 2007

(30) Foreign Application Priority Data
Mar. 29, 2006 (JP) 2006-092409

(51) Int. Cl. H01M 2/08; B29C 45/14

(52) U.S. Cl. 429/35; 264/259

(57) ABSTRACT

A fuel cell includes first and second separators sandwiching a membrane electrode assembly. The first and second separators include first and second metal plates, first and second insulating bushings for positioning the first and second metal plates in alignment with each other, and first and second seal members formed integrally with the first and second metal plates. The first and second seal members are formed by injection molding on the first and second metal plates using the first and second insulating bushings as insert members.

### BACKGROUND OF THE INVENTION

1. Field of the Invention

The present invention relates to a separator for a fuel cell stacked on an electrolyte electrode assembly. The electrolyte electrode assembly includes a pair of electrodes and an electrolyte interposed between the electrodes, to a method of producing such a separator, and to a method of assembling the fuel cell.

2. Description of the Related Art

For example, a solid polymer electrolyte fuel cell employs a membrane electrode assembly (electrolyte electrode assembly) which includes two electrodes (anode and cathode), and an electrolyte membrane interposed between the electrodes. The electrolyte membrane is a polymer ion exchange membrane. The membrane electrode assembly is sandwiched between a pair of separators. The membrane electrode assembly and the separators make up a unit cell for generating electricity.

In the fuel cell, in order to achieve the high output, several tens to hundreds of unit cells are stacked together to form stack structure. At this time, the unit cells need to be in alignment with each other accurately. In order to achieve the accurate positioning of the unit cells, typically, a knock pin is inserted in each of positioning holes formed in the unit cells.

For example, Japanese Laid-Open Patent Publication No. 2000-12067 discloses a solid polymer electrolyte fuel cell 1 shown in FIG. 10. The fuel cell 1 includes a unit cell 2 and separators 3a, 3b sandwiching the unit cell 2. The unit cell 2 includes a solid polymer electrolyte membrane 2a, an anode 2b provided on one surface of the solid polymer electrolyte membrane 2a, and a cathode 2c provided on the other surface of the solid polymer electrolyte membrane 2a.

Holes 4 extend through the fuel cell 1 in a stacking direction of the fuel cell 1 for inserting holding pins 6. The separator 3b has openings 5 for inserting snap rings 7. The holding pin 6 has a snap ring attachment groove 6a. The holding pin 6 is inserted into the hole 4, the snap ring 7 is inserted into the opening 5, and the snap ring 7 is fitted to the snap ring attachment groove 6a. At one end of the holding pin 6, a chamfered tip 6b is formed. At the other end of the holding pin 6, a hole 6c for inserting the tip 6b of another holding pin 6 is formed.

As described above, in the system of the fuel cell 1, the holding pin 6 is inserted into the hole 4, and the snap ring 7 is inserted into the opening 5. The snap ring 7 is fitted to the snap ring attachment groove 6a for tightening the fuel cell 1.

Thus, the tip 6b of the holding pin 6 projecting from the outer surface of the separator 3b is fitted to the hole 6c of another holding pin 6 which tightens another fuel cell 1. In this manner, the adjacent fuel cells 1 are stacked in alignment with each other.

However, in the conventional technique, at the time of assembling the fuel cell 1, a plurality of the holding pins 6 need to be inserted into the holes 4 for each of the unit cells 2. Further, the snap rings 7 need to be fitted to the respective snap ring attachment grooves 6a of the holding pins 6. Therefore, assembling operation of the fuel cell 1 is laborious.

In particular, when a large number of fuel cells 1 are stacked together to form a fuel cell stack, operation of assembling the respective fuel cells 1 is time consuming, and the overall assembling operation of the fuel cell stack cannot be performed efficiently.

### SUMMARY OF THE INVENTION

A main object of the present invention is to provide separators for a fuel cell, a method of producing the separators, and a method of assembling the fuel cell in which, with simple structure, separators are positioned in alignment with each other easily and reliably, and the overall assembling operation of the fuel cell is efficiently performed.

The present invention relates to a separator for a fuel cell comprising an electrolyte electrode assembly including a pair of electrodes and an electrolyte interposed between the electrodes. The separator is stacked on the electrolyte electrode assembly. The separator comprises a metal plate, a positioning member for positioning the metal plate and another metal plate that are stacked together in a stacking direction, and a seal member formed integrally with the metal plate. The seal member is formed on the metal plate by injection molding using the positioning member as an insert member.

Further, the present invention relates to a method of producing a separator for a fuel cell comprising an electrolyte electrode assembly including a pair of electrodes and an electrolyte interposed between the electrodes. The separator is stacked on the electrolyte electrode assembly. Firstly, a positioning member for positioning metal plates that are stacked together in a stacking direction, is provided in a molding die as an insert member such that the positioning member is placed in a positioning hole of at least one of the metal plates. Then, melted resin is injected in the molding die for forming a seal member integrally with the metal plate to obtain the separator.

Further, the present invention relates to a method of assembling a fuel cell by stacking first and second separators on both sides of electrolyte electrode assembly including a pair of electrodes, and an electrolyte interposed between the electrodes. Firstly, first and second positioning members for positioning first and second metal plates that are stacked together in a stacking direction, are provided in a molding die as insert members such that the first and second positioning members are placed in first and second positioning holes of the first and second metal plates.

Then, melted resin is injected in the molding die for forming first and second seal members integrally with the first and second metal plates to obtain the first and second separators. Further, the electrolyte electrode assembly is provided between the first and second separators, and the first positioning member and the second positioning member are fitted to each other for positioning the first and second separators relative to each other to obtain the fuel cell.

According to the present invention, the positioning member is placed on the metal plate, and the seal member is formed integrally with the metal plate using the positioning member as the insert member. Thus, the separator can be produced simply, and the positioning member is formed integrally with the separator. Accordingly, the separators are positioned in alignment with each other easily and reliably. As a result, the separators have economical structure, and the overall assembling operation of the fuel cell is performed efficiently.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a view schematically showing structure of a fuel cell stack formed by stacking fuel cells according to an embodiment of the present invention;

FIG. 2 is an exploded perspective view showing the fuel cell;

FIG. 3 is a front view showing a first separator of the fuel cell;

FIG. 4 is an enlarged cross sectional view showing main components of the fuel cell;

FIG. 5 is a view showing a state in which an insulating bushing is provided on a metal plate;

FIG. 6 is a view showing a state in which the metal plate is placed in a molding die and one of cavities is formed;

FIG. 7 is a view showing a state in which the metal plate is placed in the molding die and the other of the cavities is formed;

FIG. 8 is a view showing a state in which a seal member is formed on the metal plate;

FIG. 9 is a view showing a state in which another seal member is formed on the metal plate; and

FIG. 10 is an exploded perspective view showing main components of a conventional fuel cell.

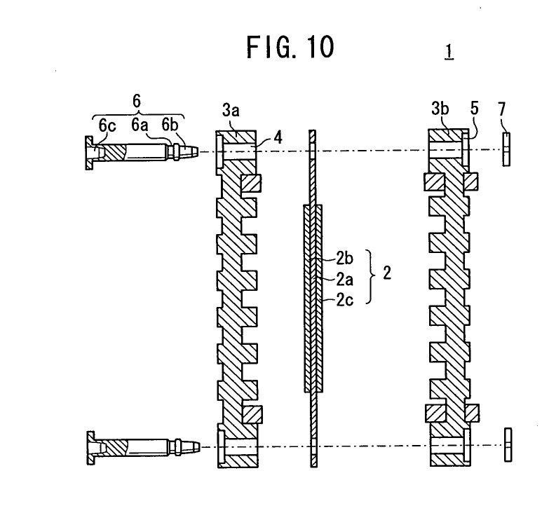

### DESCRIPTION OF THE PREFERRED EMBODIMENTS

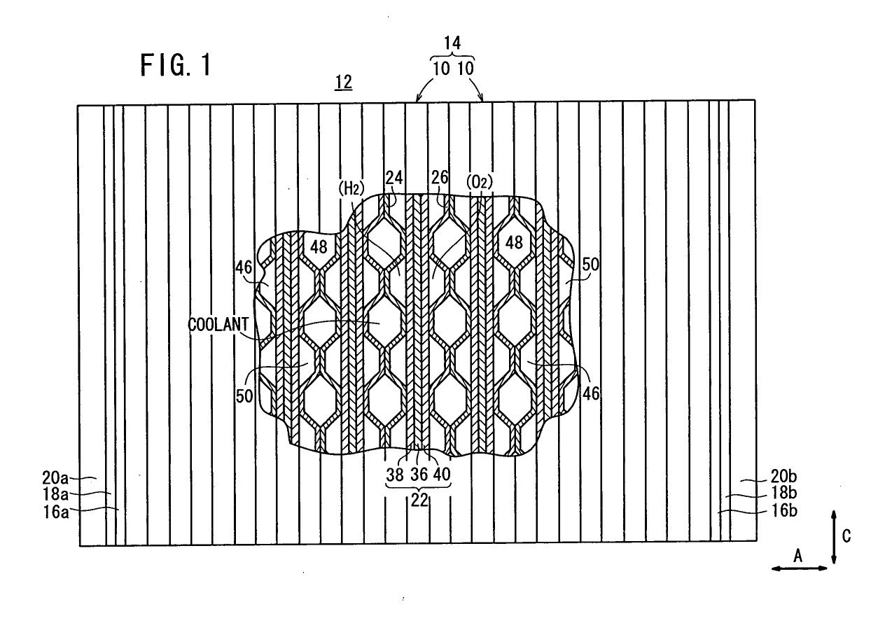

FIG. 1 is a view schematically showing structure of a fuel cell stack 12 formed by stacking fuel cells 10 according to an embodiment of the present invention.

The fuel cell stack 12 includes a stacked body 14 formed by stacking a plurality of fuel cells 10 in a direction indicated by an arrow A. Terminal plates 16a, 16b are provided on the outermost fuel cells 10 at opposite ends of the stacked body 14. Insulating plate 18a, 18b are provided outside the terminal plates 16a, 16b. Further, end plates 20a, 20b are provided outside the insulating plates 18a, 18b. A predetermined tightening load is applied to components between the end plates 20a, 20b.

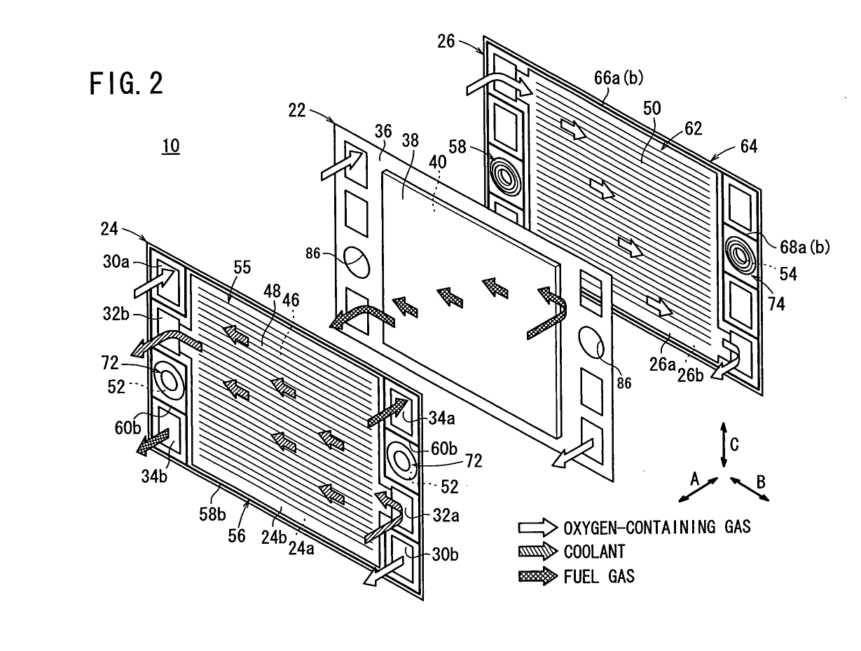

As shown in FIG. 2, the fuel cell 10 includes a membrane electrode assembly (electrolyte electrode assembly) 22, and first and second separators 24, 26 sandwiching the membrane electrode assembly 22.

At one end of the fuel cell 10 in a direction indicated by an arrow B, an oxygen-containing gas supply passage 30a for supplying an oxygen-containing gas, a coolant discharge passage 32b for discharging a coolant, and a fuel gas discharge passage 34b for discharging a fuel gas such as a hydrogen-containing gas are arranged vertically in a direction indicated by an arrow C. The oxygen-containing gas supply passage 30a, the coolant discharge passage 32b, and the fuel gas discharge passage 34b extend through the fuel cell 10 in the stacking direction indicated by the arrow A.

At the other end of the fuel cell 10 in the direction indicated by the arrow B, a fuel gas supply passage 34a for supplying the fuel gas, a coolant supply passage 32a for supplying the coolant, and an oxygen-containing gas discharge passage 30b for discharging the oxygen-containing gas are arranged vertically in the direction indicated by the arrow C. The fuel gas supply passage 34a, the coolant supply passage 32a, and the oxygen-containing gas discharge passage 30b extend through the fuel cell 10 in the direction indicated by the arrow A.

The membrane electrode assembly 22 comprises an anode 38, a cathode 40, and a solid polymer electrolyte membrane (electrolyte) 36 interposed between the anode 38 and the cathode 40. The solid polymer electrolyte membrane 36 is formed by impregnating a thin membrane of perfluorosulfonic acid with water, for example.

Each of the anode 38 and cathode 40 has a gas diffusion layer (not shown) such as a carbon paper, and an electrode catalyst layer (not shown) of platinum alloy supported on porous carbon particles. The carbon particles are deposited uniformly on the surface of the gas diffusion layer. The electrode catalyst layer of the anode 38 and the electrode catalyst layer of the cathode 40 are fixed to both surfaces of the solid polymer electrolyte membrane 36, respectively.

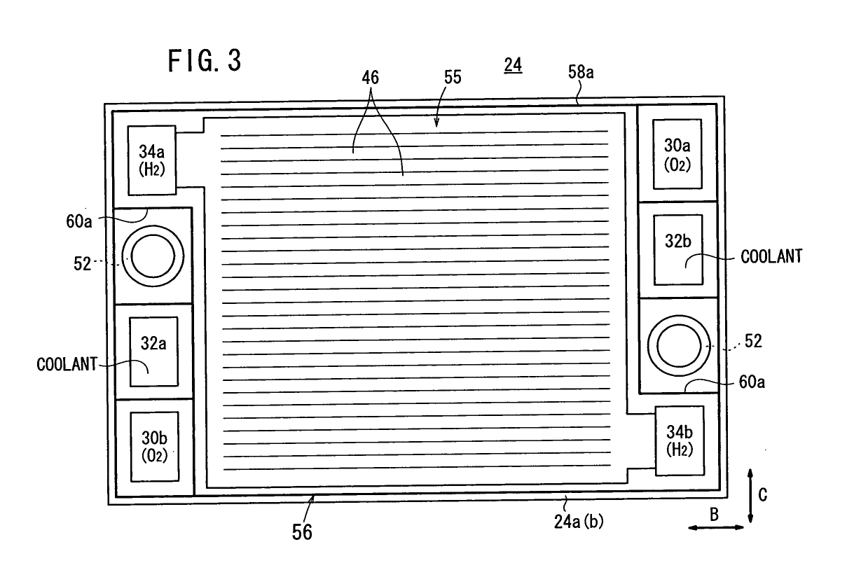

As shown in FIG. 3, the first separator 24 has a fuel gas flow field 46 on its surface 24a facing the membrane electrode assembly 22. The fuel gas flow field 46 includes a plurality of grooves extending straight in the direction indicated by the arrow B, for example. The fuel gas flow field 46 is connected to the fuel gas supply passage 34a at one end, and connected to the fuel gas discharge passage 34b at the other end.

The second separator 26 has an oxygen-containing gas flow field 50 on its surface 26a facing the membrane electrode assembly 22. The oxygen-containing gas flow field 50 includes a plurality of grooves extending straight in the direction indicated by the arrow B, for example. The oxygen-containing gas flow field 50 is connected to the oxygen-containing gas supply passage 30a at one end, and connected to the oxygen-containing gas discharge passage 30b at the other end.

As shown in FIGS. 1 and 2, a coolant flow field 48 is formed between a surface 24b of the first separator 24 and a surface 26b of the second separator 26. The coolant flow field 48 includes a plurality of grooves extending straight in the direction indicated by the arrow B. Specifically, the coolant flow field 48 is formed by combining grooves on the first separator 24 and grooves on the second separator 26 when the first and second separators 24, 26 are stacked together. The coolant flow field 48 is connected to the coolant supply passage 32a at one end, and connected to the coolant discharge passage 32b at the other end.

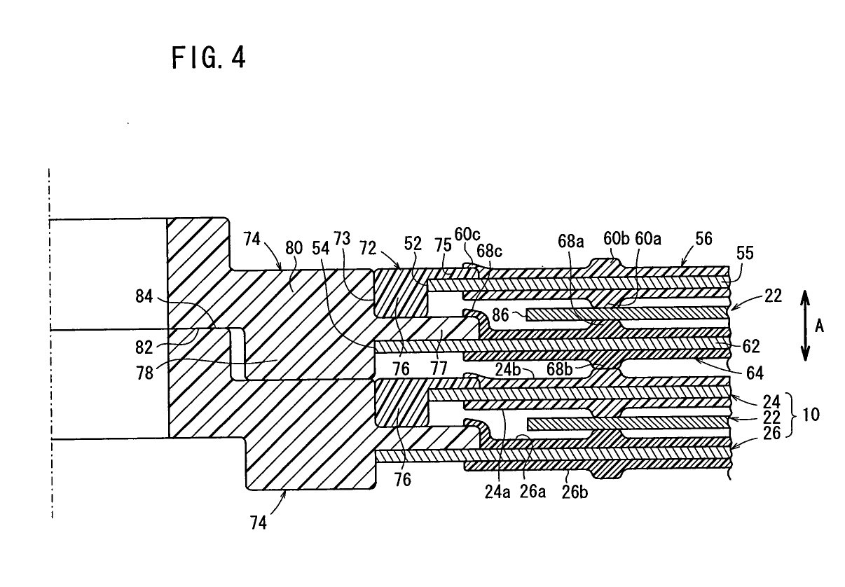

As shown in FIGS. 2 to 4, the first separator 24 has first positioning holes 52 between the coolant discharge passage 32b and the fuel gas discharge passage 34b, and between the fuel gas supply passage 34a and the coolant supply passage 32a. As shown in FIGS. 2 and 4, as in the case of the first separator 24, the second separator 26 has second positioning holes 54 between the coolant discharge passage 32b and the fuel gas discharge passage 34b, and between the fuel gas supply passage 34a and the coolant supply passage 32a.

The first separator 24 includes a first metal plate 55. A first seal member 56 is formed integrally on the surfaces 24a, 24b around the outer end of the first metal plate 55. The first seal member 56 has seal lines 58a, 58b on the surfaces 24a, 24b of the first separator 24, respectively (see FIGS. 2 and 3).

As shown in FIG. 3, the seal line 58a is provided such that the fuel gas flow field 46 is connected to the fuel gas supply passage 34a and the fuel gas discharge passage 34b, while preventing leakage of the fuel gas from the fuel gas flow field 46 to the oxygen-containing gas supply passage 30a, the oxygen-containing gas discharge passage 30b, the coolant supply passage 32a, and the coolant discharge passage 32b. The seal line 58a includes seal members 60a formed around the first positioning holes 52 in a liquid tight manner.

As shown in FIG. 2, the seal line 58b is provided such that the coolant flow field 48 is connected to the coolant supply passage 32a and the coolant discharge passage 32b, while preventing leakage of the coolant from the coolant flow field 48 to the oxygen-containing gas supply passage 30a, the oxygen-containing gas discharge passage 30b, the fuel gas supply passage 34a, and the fuel gas discharge passage 34b. The seal line 58b includes seal members 60b formed around the first positioning holes 52 in a liquid tight manner.

As shown in FIGS. 2 and 4, the second separator 26 includes a second metal plate 62. A second seal member 64 is formed integrally on the surfaces 26a, 26b around the outer end of the second metal plate 62. The second seal member 64 has seal lines 66a, 66b on the surfaces 26a, 26b of the second separator 26, respectively (see FIG. 2).

The seal line 66a is provided such that the oxygen-containing gas flow field 50 is connected to the oxygen-containing gas supply passage 30a and the oxygen-containing gas discharge passage 30b. The seal line 66a includes seal members 68a formed around the second positioning holes 54 in a liquid tight manner.

The seal line 66b is provided such that the coolant flow field 48 is connected to the coolant supply passage 32a and the coolant discharge passage 32b. The seal line 66b includes seal members 68b formed around the second positioning holes 54 in a liquid tight manner.

As shown in FIG. 4, the diameter of the first positioning hole 52 is larger than the diameter of the second positioning hole 54. A first insulating bushing (positioning member) 72 is held in the first positioning hole 52 by the first seal member 56. The first seal member 56 includes an overlapping portion 60c for holding (fixing) at least part of the first insulating bushing 72 by, for example, embedding an outer edge of a flange 75 of the first insulating bushing 72 as described later.

A second insulating bushing (positioning member) 74 is held in the second positioning hole 54 by the second seal member 64. The second seal member 64 includes an overlapping portion 68c for holing (fixing) at least part of the second insulating bushing 74 by, for example, embedding an outer edge of a flange 77 of the second insulating bushing 74 as described later.

The first and second insulating bushings 72, 74 have good insulating performance, are formed suitably by injection molding, and have suitable hardness. For example, the first and second insulating bushings 72, 74 are made of PPS (polyphenylene sulfide) or LCP (liquid crystal polymer).

The first insulating bushing 72 has a substantially ring shape with a hole 73. The first insulating bushing 72 has the flange 75 which contacts an exposed metal surface of the first metal plate 55 on the surface 24b of the first separator 24, and an expansion 76 fitted to the first positioning hole 52 of the first separator 24.

The second insulating bushing 74 has a substantially ring shape. The second insulating bushing 74 includes a flange 77 which contacts an exposed metal surface of the second metal plate 62 on the surface 26a of the second separator 26, a first expansion 78 fitted to the second positioning hole 54 of the second separator 26, and a second expansion 80 fitted to the hole 73 of the first insulating bushing 72. The second expansion 80 protrudes oppositely to the first expansion 78. The second insulating bushing 74 has a recess 82 inside the first expansion 78, and has a protrusion 84 expanding axially in the stacking direction toward the inside of the second expansion 80.

The membrane electrode assembly 22 has relief holes 86 at positions corresponding to the first and second positioning holes 52, 54, and the first and second insulating bushings 72, 74 can be inserted into the relief holes 86 (see FIGS. 2 and 4).

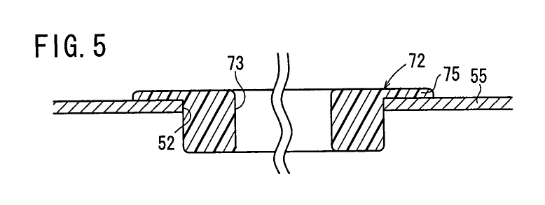

Next, operation of producing the first separator 24 will be described with reference to FIGS. 5 to 8. The second separator 26 is produced in the same manner as the first separator 24. Therefore, detailed description about operation of producing the second separator 26 will be omitted.

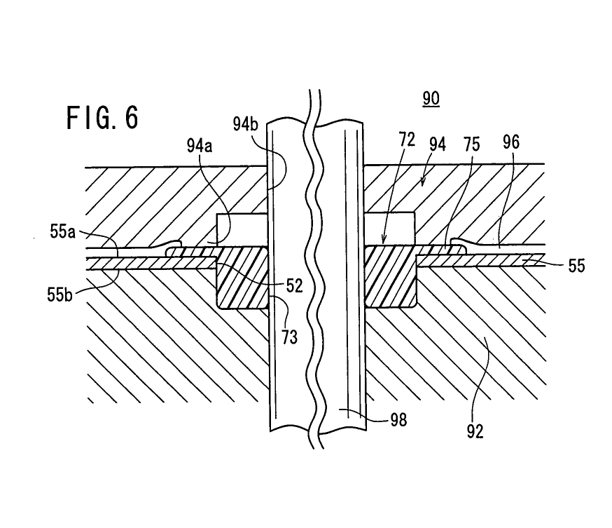

Firstly, as shown in FIG. 5, the first insulating bushing 72 is placed in the first positioning hole 52 of the first metal plate 55. As shown in FIG. 6, the first metal plate 55 is mounted in a molding die 90 using the first insulating bushing 72 as an insert member.

The molding die 90 includes an upper die 94 and a lower die 92 for positioning the first metal plate 55. The upper die 94 has a cavity 96 for forming the first seal member 56 integrally with the first metal plate 55 and the outer end of the first insulating bushing 72, and has an expansion 94a for supporting the flange 75 of the first insulating bushing 72. The upper die 94 has a hole 94b coaxially with the hole 73 of the first insulating bushing 72.

A positioning pin 98 is inserted into the holes 73, 94b. By the positioning pin 98, the first insulating bushing 72 and the upper die 94 are positioned. In the state, for example, melted resin produced by heating silicone resin to a predetermined temperature (e.g., 160° C. to 170° C.) is injected into the cavity 96.

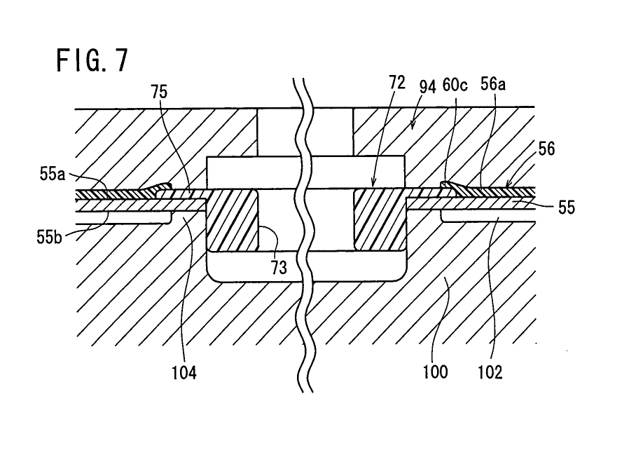

By hardening the melted resin filled in the cavity 96, a seal 56a of the first seal member 56 is formed on one surface 55a of the first metal plate 55 (see FIG. 7). The seal 56a includes the overlapping portion 60c where the outer edge of the flange 75 of the first insulating bushing 72 is embedded.

Then, as shown in FIG. 7, instead of the lower die 92, a lower die 100 for molding is used. The lower die 100 has a cavity 102 on the side of the other surface 55b of the first metal plate 55, and an expansion 104 for supporting the first metal plate 55.

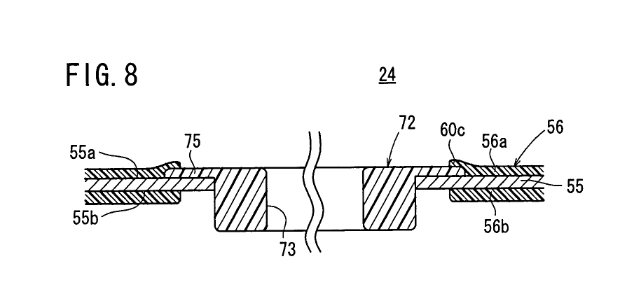

In the same manner as described above, melted resin is filled in the cavity 102. By cooling the melted resin for a predetermined period of time, the other seal 56b of the first seal member 56 is formed on the other surface 55b of the first metal plate 55 (see FIG. 8). Thus, the first separator 24 is produced.

As shown in FIG. 6, the positioning pin 98 is used for positioning the first insulating bushing 72 and the upper die 94. However, it is not essential to use the positioning pin 98. For example, the first metal plate 55 may have a positioning hole (not shown) for positioning the first metal plate 55 and the upper die 94.

Further, the molding die 90 includes the upper die 94 and the lower die 100 for performing injection molding on one surface 55a and the other surface 55b of the first metal plate 55 separately to form the respective seals 56a, 56b. Alternatively, the seals 56a, 56b may be formed by molding on one surface 55a and the other surface 55b at the same time.

In the embodiment, the first insulating bushing 72 as the insert member is placed on the first metal plate 55. In this state, the first seal member 56 is formed integrally with the first metal plate 55. By the overlapping portion 60c of the first seal member 56, the first insulating bushing 72 is held on the first metal plate 55 to form the first separator 24.

Likewise, in the second separator 26, the second seal member 64 is formed integrally with the second metal plate 62. By the overlapping portion 68c of the second seal member 64, the second insulating bushing 74 as an insert member is held in the second metal plate 62.

In the structure, operation of producing the first and second metal separators 24, 26 is simplified effectively, and the first and second insulating bushings 72, 74 are formed integrally with the first and second separators 24, 26. Thus, the first and second separators 24, 26 are positioned in alignment with each other simply and reliably.

Specifically, the membrane electrode assembly 22 is sandwiched between the first and second separators 24, 26, and the second expansion 80 of the second insulating bushing 74 held by the second separator 26 is fitted to the hole 73 of the first insulating bushing 72 held by the first separator 24 (see FIG. 4). Thus, the first and second separators 24, 26 sandwiching the membrane electrode assembly 22 are positioned in alignment with each other.

Accordingly, the first and second separators 24, 26 have economical and simple structure, and the fuel cell 10 is assembled efficiently. Further, the overall assembling operation of the fuel cell stack 12 formed by stacking the fuel cells 10 can be performed efficiently.

In assembling the fuel cells 10, the adjacent fuel cells 10 are positioned with respect to each other by fitting the protrusion 84 of the second insulating bushing 74 in the recess 82 of the adjacent second insulating bushing 74.

Next, operation of the fuel cell 10 and the fuel cell stack 12 will be described below.

An oxygen-containing gas such as the air, a fuel gas such as a hydrogen-containing gas, and a coolant such as pure water or ethylene glycol are supplied into the fuel cell stack 12. Thus, as shown in FIG. 2, the oxygen-containing gas is supplied from the oxygen-containing gas supply passage 30a into the oxygen-containing gas flow field 50 of the second separator 26. The oxygen-containing gas flows along the cathode 40 of the membrane electrode assembly 22.

The fuel gas flows from the fuel gas supply passage 34a into the fuel gas flow field 46 of the first separator 24. The fuel gas flows along the anode 38 of the membrane electrode assembly 22.

Thus, in the membrane electrode assembly 22, the oxygen-containing gas supplied to the cathode 40, and the fuel gas supplied to the anode 38 are consumed in the electrochemical reactions at catalyst layers of the cathode 40 and the anode 38 for generating electricity.

After the oxygen-containing gas is consumed at the cathode 40, the oxygen-containing gas flows into the oxygen-containing gas discharge passage 30b, and flows in the direction indicated by the arrow A. Similarly, after the fuel gas is consumed at the anode 38, the fuel gas flows into the fuel gas discharge passage 34b, and flows in the direction indicated by the arrow A.

The coolant supplied to the coolant supply passage 32a flows into the coolant flow field 48 between the first and second metal separators 24, 26, and flows in the direction indicated by the arrow B. After the coolant is used for cooling the membrane electrode assembly 22, the coolant is discharged into the coolant discharge passages 32b.

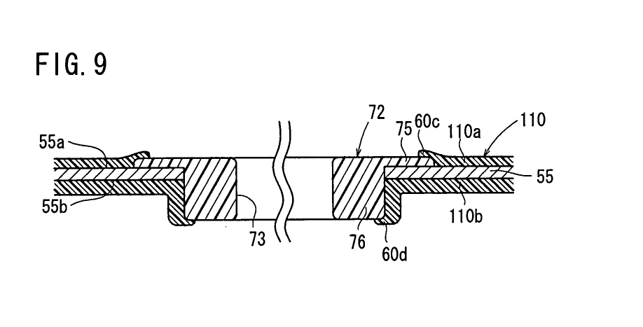

In the embodiment, as shown in FIG. 8, the first seal member 56 has the overlapping portion 60c where only the outer edge of the flange 75 of the first insulating bushing 72 is embedded. However, the embodiment can be modified depending on the structure of the fuel cell 10. For example, a first seal member 110 as shown in FIG. 9 may be used.

The first seal member 110 includes a seal 110a formed integrally with one surface 55a of the first metal plate 55, and a seal 110b formed integrally with the other surface 55b of the first metal plate 55. The seal 110a has an overlapping portion 60c where the outer edge of the flange 75 of the first insulating bushing 72 is embedded, and the seal 10b has an overlapping portion 60d where the outer edge of the expansion 76 of the first insulting bushing 72 is embedded.

In the structure, the outer edge having the large diameter and the outer edge having the small diameter are embedded by the overlapping portions 60c, 60d. The first insulating bushing 72 is reliably and securely held on the first metal plate 55. Though not shown, the second insulating bushing has the same structure.

While the invention has been particularly shown and described with reference to the preferred embodiment, it will be understood that variations and modifications can be effected thereto by those skilled in the art without departing from the spirit and scope of the invention as defined by the appended claims.

What is claimed is:

1. A separator for a fuel cell comprising an electrolyte electrode assembly including a pair of electrodes and an electrolyte interposed between said electrodes, said separator being stacked on said electrolyte electrode assembly, and comprising:
a metal plate;
a positioning member for positioning said metal plate and another metal plate that are stacked together in a stacking direction; and
a seal member formed integrally with said metal plate,
wherein said seal member is formed on said metal plate by injection molding using said positioning member as an insert member.

2. A separator according to claim 1, wherein said positioning member is at least partially embedded under said seal member such that said positioning member is held by said metal plate.

3. A separator according to claim 2, wherein said positioning member comprises:
an expansion fitted to a positioning hole of said metal plate; and
a flange which contacts metal exposed surface of said metal plate and which is at least partially embedded under said seal member.

4. A method of producing a separator for a fuel cell comprising an electrolyte electrode assembly including a pair of electrodes and an electrolyte interposed between said electrodes, said separator being stacked on said electrolyte electrode assembly, said method comprising the steps of:
providing a positioning member for positioning metal plates that are stacked together in a stacking direction, in a molding die as an insert member such that said positioning member is placed in a positioning hole of at least one of said metal plates; and
injecting melted resin in said molding die for forming a seal member integrally with said metal plate to obtain said separator.

5. A method according to claim 4, wherein said positioning member is at least partially embedded under said seal member such that said positioning member is held by said metal plate.

6. A method according to claim 5, wherein an expansion of said positioning member is fitted to said positioning hole of said meta plate, and a flange of said positioning member is at least partially embedded under said seal member such that said flange contacts a metal exposed surface of said metal plate.

7. A method of assembling a fuel cell by stacking first and second separators on both sides of electrolyte electrode assembly including a pair of electrodes, and an electrolyte interposed between said electrodes, the method comprising the steps of:
providing first and second positioning members for positioning first and second metal plates that are stacked together in a stacking direction, in a molding die as insert members such that said first and second positioning members are placed in first and second positioning holes of said first and second metal plates;
injecting melted resin in said molding die for forming first and second seal members integrally with said first and second metal plates to obtain said first and second separators; and
providing said electrolyte electrode assembly between said first and second separators, and fitting said first positioning member and said second positioning member to each other for positioning said first and second separators relative to each other to obtain said fuel cell.

8. A method according to claim 7, wherein said first and second positioning members are at least partially embedded under said first and second seal members such that said first and second positioning members are held by said first and second metal plates.

9. A method according to claim 8, wherein expansions of said first and second positioning members are fitted to said first and second positioning holes of said first and second metal plates, and flanges of said first and second positioning members are at least partially embedded under said first and second seal members such that said flanges contact metal exposed surfaces of said first and second metal plates.
